(19) United States
(12) Patent Application Publication
(10) Pub. No.: US 2025/0150890 A1
(43) Pub. Date: May 8, 2025

(54) SYSTEMS AND METHODS FOR NETWORK SCHEDULING THAT PRIORITIZES GAMING TRAFFIC FOR USER EQUIPMENTS ASSOCIATED WITH NETWORK SLICING

(71) Applicant: Verizon Patent and Licensing Inc., Basking Ridge, NJ (US)

(72) Inventors: Yong Sang CHO, Old Tappan, NJ (US); Lily ZHU, Parsippany, NJ (US); Jeremy NACER, Boca Raton, FL (US)

(73) Assignee: Verizon Patent and Licensing Inc., Basking Ridge, NJ (US)

(21) Appl. No.: 18/503,842

(22) Filed: Nov. 7, 2023

(51) Int. Cl. H04W 28/02; H04W 72/566

(52) U.S. Cl. CPC H04W 28/0268; H04W 72/569

(57) ABSTRACT

In some implementations, a network element may identify gaming traffic associated with a user equipment (UE). The network element may detect a traffic pattern associated with the gaming traffic. The network element may determine that the UE is associated with a prioritized service, wherein the prioritized service is associated with network slicing. The network element may perform a network scheduling for the UE that prioritizes the gaming traffic associated with the UE over non-gaming traffic associated with another UE, wherein the network scheduling is based on the traffic pattern and the UE being associated with the prioritized service.

### BACKGROUND

Wireless communication systems are widely deployed to provide various telecommunication services such as telephony, video, data, messaging, and broadcasts. A wireless network may include one or more network nodes that support communication for wireless communication devices, such as a user equipment (UE).

### BRIEF DESCRIPTION OF THE DRAWINGS

FIG. 1 is a diagram of an example associated with network scheduling that prioritizes gaming traffic for user equipments (UEs) associated with network slicing.

FIG. 2 is a diagram of an example associated with network scheduling that prioritizes gaming traffic for UEs associated with network slicing.

FIG. 3 is a diagram of an example environment in which systems and/or methods described herein may be implemented.

FIG. 4 is a diagram of example components of one or more devices of FIG. 3.

FIG. 5 is a flowchart of an example process associated with network scheduling that prioritizes gaming traffic for UEs associated with network slicing.

### DETAILED DESCRIPTION OF EXAMPLE EMBODIMENTS

The following detailed description of example implementations refers to the accompanying drawings. The same reference numbers in different drawings may identify the same or similar elements.

In a wireless network, such as a Fifth Generation (5G) New Radio (NR) network or a Long Term Evolution (LTE) network, a key performance differentiation may be consistent low latency and consistent low jitter, especially for a gaming application executing on a user equipment (UE). An ability to provide consistent low latency and jitter performance for the gaming application may be challenging when the wireless network is congested. A gaming traffic pattern in a downlink direction may be bursty with a periodicity defined by a frame rate. The wireless network should be able to deliver all of the packets for each video frame within a certain time window. Otherwise, when a packet for the video frame is not delivered within the time window, the gaming application may drop the packet and subsequently drop a corresponding video frame. A network latency variation may depend on a distance between an application server and the UE, a transport capacity, a capacity of a radio access network (RAN), and/or a network loading. The network loading may depend on a number of UEs that are on the wireless network. When the wireless network is congested, a probability of a packet delay may be increased, which may lead to a video quality degradation.

The wireless network may be associated with slicing or non-slicing. Network slicing may overlay multiple virtual networks on top of a shared network domain, which may include a set of shared network and computing resources. Network slicing may allow traffic resources to be controlled on a more granular level, as each slice of traffic may have its own resource requirements, quality of service (QoS), security configurations, and/or latency requirements. Latency may be an issue for network slicing when the wireless network is loaded. For example, with heavy loading (e.g., high congestion), a round trip time (RTT) (in milliseconds (ms)) and a video jitter (in ms) may be relatively poor for both slicing and non-slicing. The RTT may be associated with an end-to-end latency. The RTT and the video jitter may be associated with periodic spikes during heavy loading, which may degrade an overall experience. With medium loading (e.g., medium congestion), an RTT and a video jitter may be moderately affected by non-slicing (e.g., non-slicing may have a medium impact on the RTT and the video jitter). The RTT and the video jitter may be associated with periodic spikes during medium loading, but such spikes may be less than spikes associated with heavy loading. With medium loading, an RTT and a video jitter may not be impacted (or minimally impacted) by slicing.

In the wireless network, providing consistent low latency and jitter performance may be challenging when the wireless network is congestion. Depending on whether the wireless network is heavily loaded or medium loaded, and depending on whether the wireless network is associated with slicing or non-slicing (no slicing), latency and/or video packet jitter may be negatively affected, thereby degrading an overall network performance.

In some implementations, a network node in the wireless network may optimize a radio resource scheduler to support a required service level agreement (SLA) for a gaming service. The network node may properly handle video frames (e.g., efficiently prioritize video frames) for a gaming user associated with a UE when the wireless network is congested. A network handling of video frames may be based on a gaming traffic detection. The gaming traffic detection may be based on a real-time transport protocol (RTP) packet header, or the gaming traffic detection may be based on a slice identifier mapping to a particular QoS flow. The network handling of video frames may be based on a traffic pattern detection. A pattern of gaming traffic may be identified by an artificial intelligence and/or machine learning (AI/ML) model that runs on the wireless network. The network handling of video frames may be based on a prioritization of radio resources, where the prioritization may be based on the gaming traffic detection and the traffic pattern detection.

In some implementations, in a network scheduler enhancement for gaming applications, the network node may identify a user type as a gaming user based on a service profile. The network node may detect characteristics of a gaming traffic pattern and determine a scheduling policy for a corresponding gaming user, which may be separated into a different queue for special treatment. The network node may determine a periodicity and a duration of a scheduling prioritization based on a detected traffic profile for the gaming user. A network scheduling prioritization may start when a first packet of a video frame is in a buffer, and the network scheduling prioritization may stop when a last packet of the video frame is transmitted to a UE associated with the gaming user. A starting and a stopping of the network scheduling prioritization may ensure that an uplink traffic pattern is created and data is prioritized since gaming may have response dependencies on both uplink and downlink links. The network scheduling prioritization for the gaming user may resume when a first packet is in the buffer for a next video frame. In some cases, the gaming traffic pattern may also be signaled to the network node when the network node fails to detect the gaming traffic pattern, or when the network node does not have a detection capability of the gaming traffic pattern. In some implementations, other conditions may start the prioritization. For example, a location of the buffer may be any network element such as the core network element(s) or a scheduler of a network node (e.g., an eNB/gNB).

In some implementations, by prioritizing video frames when the wireless network is congested, an overall scheduler efficiency and a QoS may be improved. The network node may optimize radio resource scheduling, which may enable a required SLA to be satisfied for a gaming service. Further, by properly handling video frames for gaming users based on the gaming traffic detection, the traffic pattern detection, and the prioritization of radio resources, a latency and a jitter performance may be improved, thereby providing an overall performance for the UE.

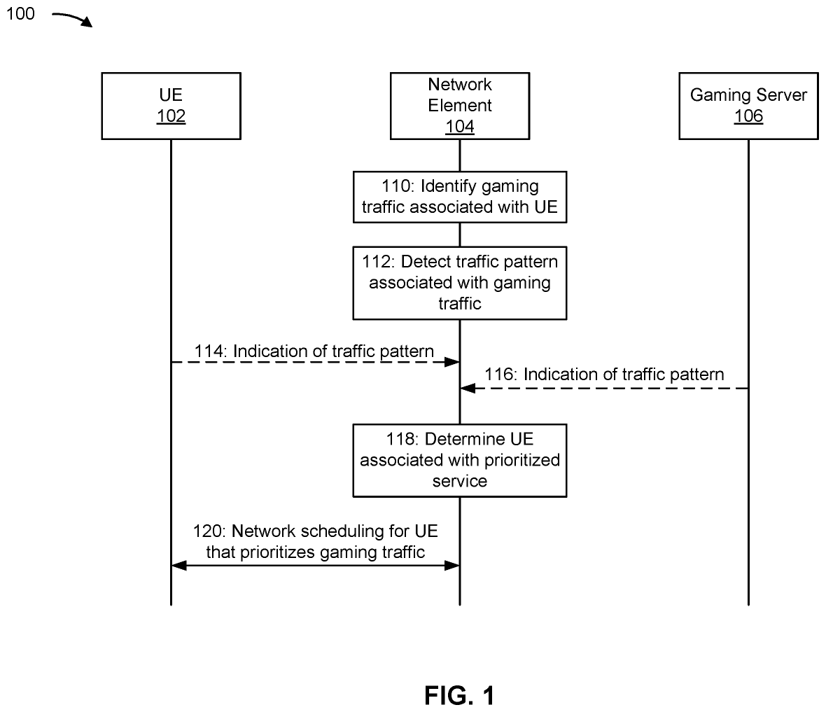

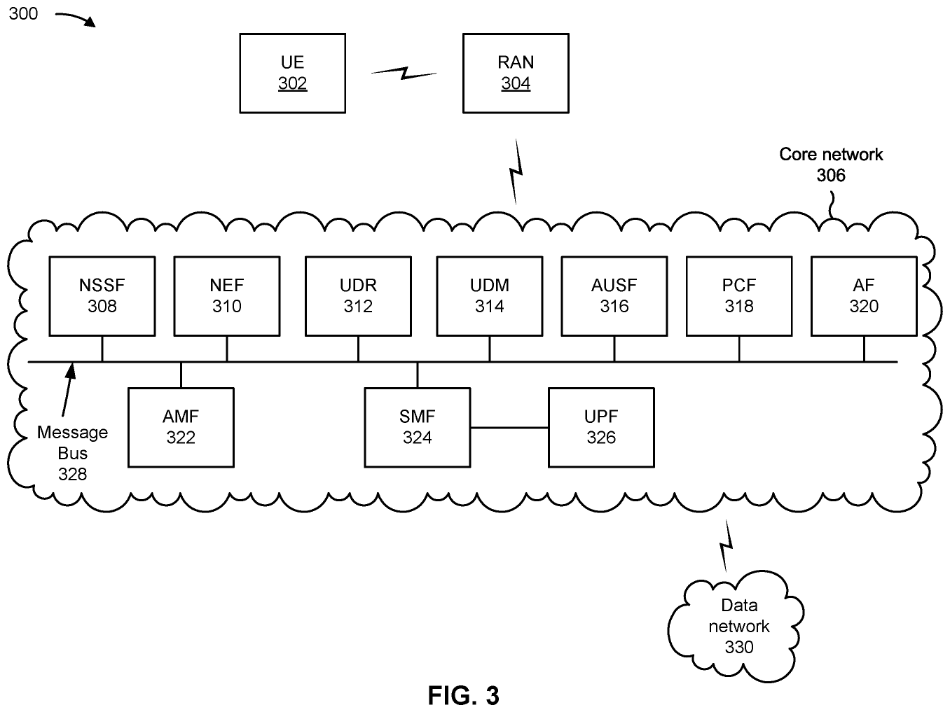

FIG. 1 is a diagram of an example 100 associated with network scheduling that prioritizes gaming traffic for UEs associated with network slicing. As shown in FIG. 1, example 100 includes a UE 102, a network element 104, and a gaming server 106. The network element 104 may be a device in a core network (e.g., a device shown in FIG. 3).

As shown by reference number 110, the network element 104 may identify gaming traffic associated with the UE 102. The network element may identify the gaming traffic based on an RTP packet header. The network element may identify the gaming traffic based on a slice identifier mapping to a QoS flow. The network element may identify the gaming traffic based on a service profile.

As shown by reference number 112, the network element 104 may detect a traffic pattern associated with the gaming traffic. The network element 104 may detect the traffic pattern based on an AI/ML function. For example, the network element 104 may run the AI/ML function, which may serve to identify the traffic pattern associated with the gaming traffic. The network element 104, via the AI/ML function, may detect the traffic pattern based on a duty cycle, a transmission window, and/or a periodicity associated with a video frame. The periodicity may be associated with the traffic pattern. Alternatively, as shown by reference number 114, the network element 104 may receive, from the UE 102, an indication of the traffic pattern. Alternatively, as shown by reference number 116, the network element 104 may receive, from the gaming server 106, an indication of the traffic pattern. In these cases, the network element 104 may not determine the traffic pattern itself, but rather may receive an indication of the traffic pattern from the UE 102 or the gaming server 106.

As shown by reference number 118, the network element 104 may determine that the UE 102 is associated with a prioritized service. The prioritized service may be associated with a network slicing. A network non-slicing may not be associated with the prioritized service.

As shown by reference number 120, the network element 104 may perform a network scheduling for the UE 102 that prioritizes the gaming traffic associated with the UE 102 over non-gaming traffic associated with another UE. The network scheduling may be based on the traffic pattern and the UE 102 being associated with the prioritized service. The network element 104 may determine a periodicity and a duration of a scheduling prioritization based on the traffic pattern. The scheduling prioritization may start when a first packet of a video frame is in a buffer and stop when a last packet of the video frame is transmitted to the UE 102. The scheduling prioritization may be resumed when a first packet is in the buffer for a next video frame. The network scheduling for the gaming traffic may be associated with prioritized resources, and non-prioritized resources may be useable for non-gaming access in between gaming traffic or while game data is being loaded or rendered. The network scheduling may prioritize the gaming traffic during a transmission window for the video frame.

In some implementations, in a scheduler prioritization for gaming access, higher scheduling priority may be assigned for slicing users, as compared to non-slicing users. A network scheduler associated with the network element 104 may prioritize the gaming traffic over the non-gaming traffic. Further, in the scheduler prioritization for gaming access, scheduler awareness may be implemented for gaming traffic identification. During a traffic pattern detection, the network element 104 (e.g., a core network element function) that supports the AI/ML function may detect the traffic pattern of a gaming user traffic by learning the duty cycle, the transmission window, and/or the periodicity for each video frame. The network element 104 may detect the traffic pattern by incorporating known endpoint Internet Protocol (IP) addresses of mobile edge computing (MEC) servers and/or gaming servers. The network element 104 may constantly evaluate the traffic pattern and profile, such that radio resources may be freed up for non-gaming access in between electronic games or while an electronic game is being loaded/rendered. Alternatively, the UE 102 and/or the gaming server 106 may send a traffic pattern model in use to the network element 104.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

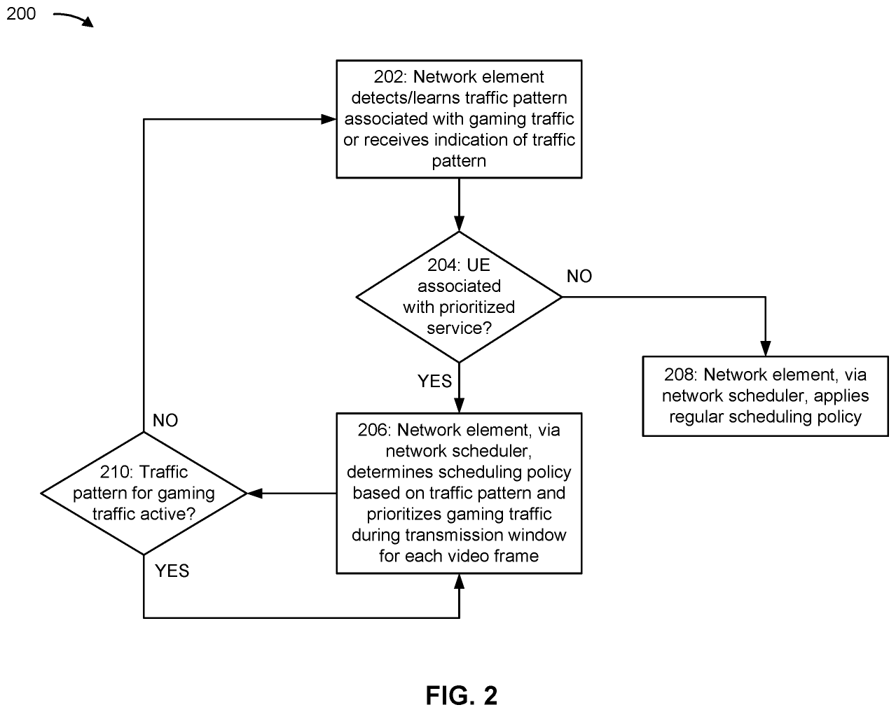

FIG. 2 is a diagram of an example 200 associated with network scheduling that prioritizes gaming traffic for UEs associated with network slicing.

As shown by reference number 202, a network element (e.g., a gNB or an eNB) may detect/learn a traffic pattern associated with gaming traffic, or the network element may receive an indication of the traffic pattern. An AI/ML function associated with the network element may detect/learn a video gaming traffic pattern. Alternatively, a UE or an application server may send a traffic pattern model to the network element. The network element may use the traffic pattern model received from the UE or the application server, if available, or the network element may use the detected traffic pattern from the AI/ML function.

As shown by reference number 204, the network element may determine whether the UE is associated with a prioritized service (e.g., whether a subscriber associated with the UE is on the prioritized service). The prioritized service may be associated with network slicing. When the UE is associated with the prioritized service, the UE may be associated with network slicing. When the UE is not associated with the prioritized service, the UE may not be associated with network slicing (or network non-slicing).

As shown by reference number 206, when the UE is associated with the prioritized service (e.g., the UE is associated with network slicing), the AI/ML function may provide the traffic pattern associated with the UE to a network scheduler associated with the network element. The network scheduler may be a separate function of the network element. Alternatively, the UE or the application server may directly indicate the traffic pattern model to the network scheduler. The network scheduler may determine a scheduling policy for a gaming user associated with the UE based on the traffic pattern (or traffic pattern model). The network scheduler may prioritize gaming user traffic during a transmission window for each video frame, so that network resources are prioritized for the gaming user only during the transmission window for each video frame.

As shown by reference number 208, when the UE is not associated with the prioritized service (e.g., the UE is not associated with network slicing), the network scheduler may apply a regular scheduling policy for the UE associated with the gaming user. In this case, the network scheduler may not prioritize gaming user traffic during a transmission window for each video frame. Some users may be associated with the prioritized service, while other users may not be associated with the prioritized service.

As shown by reference number 210, the network element may continue to evaluate the traffic pattern while a gaming session is active. When the traffic pattern is active, no additional action may be taken. When the traffic pattern is not active, the AI/ML function may repeat a detection/learning operation to detect/learn the video gaming traffic pattern.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

FIG. 3 is a diagram of an example environment 300 in which systems and/or methods described herein may be implemented. As shown in FIG. 3, example environment 300 may include a UE 302, a RAN 304, a core network 306, and a data network 330. Devices and/or networks of example environment 300 may interconnect via wired connections, wireless connections, or a combination of wired and wireless connections.

The UE 302 may include one or more devices capable of receiving, generating, storing, processing, and/or providing information, such as information described herein. For example, The UE 302 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The RAN 304 may support, for example, a cellular radio access technology (RAT). The RAN 304 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 302. A base station may be a disaggregated base station. The disaggregated base station may be configured to utilize a protocol stack that is physically or logically distributed among two or more nodes, which may include a radio unit (RU), a distributed unit (DU), and a centralized unit (CU). The RAN 304 may transfer traffic between the UE 302 (e.g., using a cellular RAT), one or more base stations (e.g., using a wireless interface or a backhaul interface, such as a wired backhaul interface), and/or the core network 306. The RAN 304 may provide one or more cells that cover geographic areas.

In some implementations, the RAN 304 may perform scheduling and/or resource management for the UE 302 covered by the RAN 304 (e.g., the UE 302 covered by a cell provided by the RAN 304). In some implementations, the RAN 304 may be controlled or coordinated by a network controller, which may perform load balancing, network-level configuration, and/or other operations. The network controller may communicate with the RAN 304 via a wireless or wireline backhaul. In some implementations, the RAN 304 may include a network controller, a self-organizing network (SON) module or component, or a similar module or component. In other words, the RAN 304 may perform network control, scheduling, and/or network management functions (e.g., for uplink, downlink, and/or sidelink communications of the UE 302 covered by the RAN 304).

In some implementations, the core network 306 may include an example functional architecture in which systems and/or methods described herein may be implemented. For example, the core network 306 may include an example architecture of a 5G next generation (NG) core network included in a 5G wireless telecommunications system. While the example architecture of the core network 306 shown in FIG. 3 may be an example of a service-based architecture, in some implementations, the core network 306 may be implemented as a reference-point architecture and/or a 4G core network, among other examples.

As shown in FIG. 3, the core network 306 include a number of functional elements. The functional elements may include, for example, a network slice selection function (NSSF) 308, a network exposure function (NEF) 310, a unified data repository (UDR) 312, a unified data management (UDM) 314, an authentication server function (AUSF) 316, a policy control function (PCF) 318, an application function (AF) 320, an access and mobility management function (AMF) 322, a session management function (SMF) 324, and/or a user plane function (UPF) 326. These functional elements may be communicatively connected via a message bus 328. Each of the functional elements shown in FIG. 3 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 308 may include one or more devices that select network slice instances for the UE 302. The NSSF 308 may allow an operator to deploy multiple substantially independent end-to-end networks potentially with the same infrastructure. In some implementations, each slice may be customized for different services. The NEF 310 may include one or more devices that support exposure of capabilities and/or events in the wireless telecommunications system to help other entities in the wireless telecommunications system discover network services.

The UDR 312 may include one or more devices that provide a converged repository, which may be used by network functions to store data. For example, a converged repository of subscriber information may be used to service a number of network functions. The UDM 314 may include one or more devices to store user data and profiles in the wireless telecommunications system. The UDM 314 may generate authentication vectors, perform user identification handling, perform subscription management, and perform other various functions. The AUSF 316 may include one or more devices that act as an authentication server and support the process of authenticating the UE 302 in the wireless telecommunications system.

The PCF 318 may include one or more devices that provide a policy framework that incorporates network slicing, roaming, packet processing, and/or mobility management, among other examples. The AF 320 may include one or more devices that support application influence on traffic routing, access to the NEF 310, and/or policy control, among other examples. The AMF 322 may include one or more devices that act as a termination point for non-access stratum (NAS) signaling and/or mobility management, among other examples. The SMF 324 may include one or more devices that support the establishment, modification, and release of communication sessions in the wireless telecommunications system. For example, the SMF 324 may configure traffic steering policies at the UPF 326 and/or may enforce UE IP address allocation and policies, among other examples. The UPF 326 may include one or more devices that serve as an anchor point for intra-RAT and/or inter-RAT mobility. The UPF 326 may apply rules to packets, such as rules pertaining to packet routing, traffic reporting, and/or handling user plane QoS, among other examples. The message bus 328 may represent a communication structure for communication among the functional elements. In other words, the message bus 328 may permit communication between two or more functional elements.

The data network 330 may include one or more wired and/or wireless data networks. For example, the data network 330 may include an IP multimedia subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of example environment 300 may perform one or more functions described as being performed by another set of devices of example environment 300.

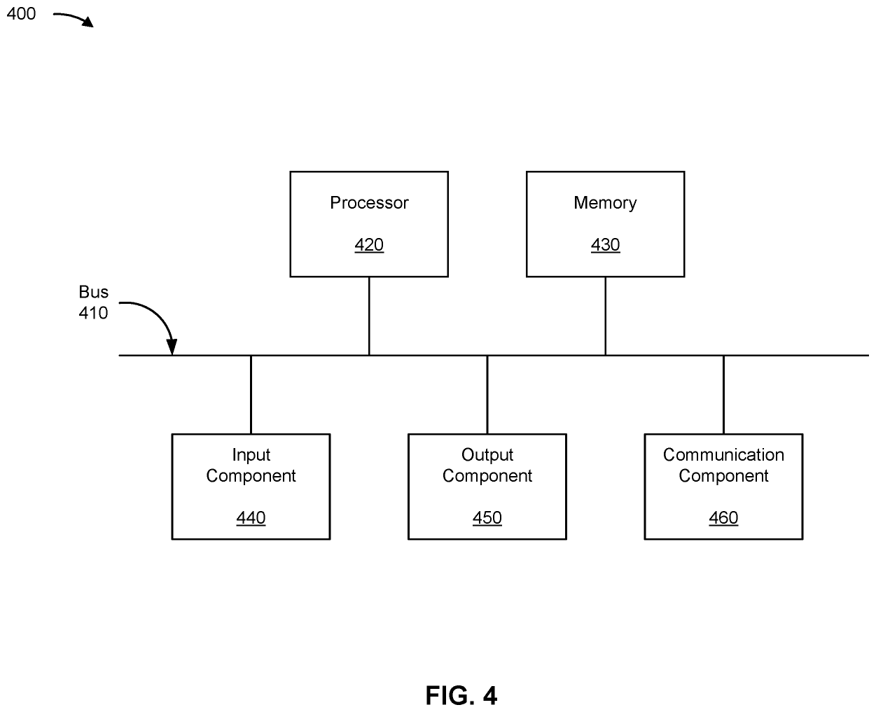

FIG. 4 is a diagram of example components of a device 400 associated with network scheduling that prioritizes gaming traffic for UEs associated with network slicing. The device 400 may correspond to a network element (e.g., network element 104). In some implementations, the network element may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

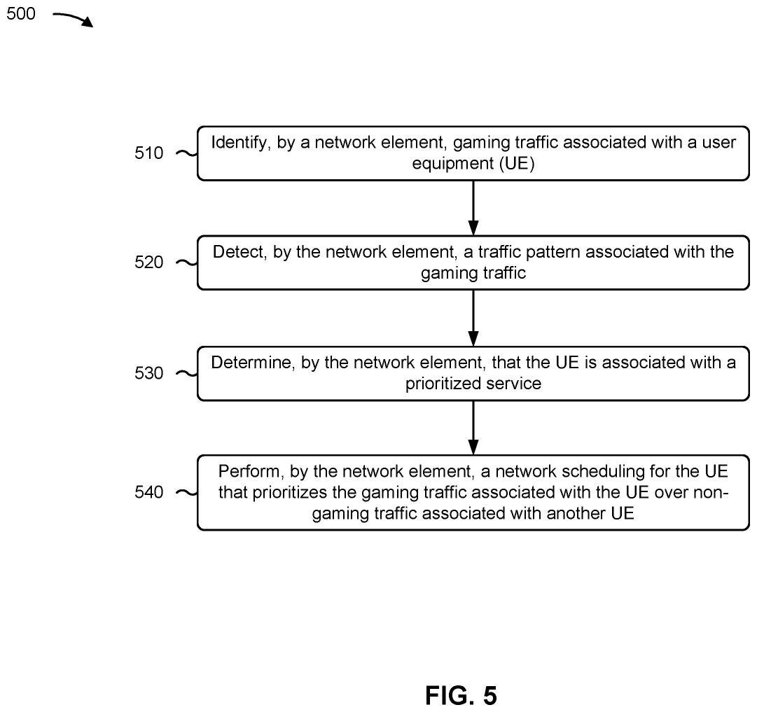

FIG. 5 is a flowchart of an example process 500 associated with network scheduling that prioritizes gaming traffic for UEs associated with network slicing. In some implementations, one or more process blocks of FIG. 5 may be performed by a network element. In some implementations, one or more process blocks of FIG. 5 may be performed by another entity or a group of entities separate from or including the network element. Additionally, or alternatively, one or more process blocks of FIG. 5 may be performed by one or more components of device 400, such as processor 420, memory 430, input component 440, output component 450, and/or communication component 460.

As shown in FIG. 5, process 500 may include identifying gaming traffic associated with a UE (block 510). The network element may identify the gaming traffic based on an RTP packet header. The network element may identify the gaming traffic based on a slice identifier mapping to a QoS flow. The network element may identify the gaming traffic based on a service profile.

As shown in FIG. 5, process 500 may include detecting a traffic pattern associated with the gaming traffic (block 520). The network element may detect the traffic pattern based on a network AI/ML function. The network element may detect the traffic pattern based on a duty cycle, a transmission window, and/or a periodicity associated with a video frame. Alternatively, the network element may receive, from the UE or a gaming server, the indication of the traffic pattern.

As shown in FIG. 5, process 500 may include determining that the UE is associated with a prioritized service (block 530). The prioritized service may be associated with a network slicing. A network non-slicing may not be associated with the prioritized service.

As shown in FIG. 5, process 500 may include performing a network scheduling for the UE that prioritizes the gaming traffic associated with the UE over non-gaming traffic associated with another UE, wherein the network scheduling is based on the traffic pattern and the UE being associated with the prioritized service (block 540). The network element may determine a periodicity and a duration of a scheduling prioritization based on the traffic pattern. The scheduling prioritization may start when a first packet of a video frame is in a buffer and stop when a last packet of the video frame is transmitted to the UE. The scheduling prioritization may be resumed when a first packet is in the buffer for a next video frame. The network scheduling for the gaming traffic may be associated with prioritized resources, and non-prioritized resources may be useable for non-gaming access in between gaming traffic or while game data is being loaded or rendered. The network scheduling may prioritize the gaming traffic during a transmission window for the video frame.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
identifying, by a network element, gaming traffic associated with a user equipment (UE);
detecting, by the network element, a traffic pattern associated with the gaming traffic;
determining, by the network element, that the UE is associated with a prioritized service, wherein the prioritized service is associated with network slicing; and
performing, by the network element, a network scheduling for the UE that prioritizes the gaming traffic associated with the UE over non-gaming traffic associated with another UE, wherein the network scheduling is based on the traffic pattern and the UE being associated with the prioritized service.

2. The method of claim 1, wherein identifying the gaming traffic comprises:
identifying the gaming traffic based on a real-time transport protocol (RTP) packet header.

3. The method of claim 1, wherein identifying the gaming traffic comprises:
identifying the gaming traffic based on a slice identifier mapping to a quality of service (QoS) flow.

4. The method of claim 1, wherein identifying the gaming traffic is based on a service profile.

5. The method of claim 1, wherein detecting the traffic pattern is based on a network artificial intelligence or machine learning (AI/ML) function.

6. The method of claim 1, wherein detecting the traffic pattern is based on one or more of a duty cycle, a transmission window, or a periodicity associated with a video frame.

7. The method of claim 1, further comprising:
determining a periodicity and a duration of a prioritization based on the traffic pattern, wherein the prioritization starts when a first packet of a video frame is in a buffer and stops when a last packet of the video frame is transmitted to the UE, the prioritization is resumed when a first packet is in the buffer for a next video frame, and a location of the buffer is at a core network element or a scheduler of a network node.

8. The method of claim 1, wherein the network scheduling for the gaming traffic is associated with prioritized resources, and non-prioritized resources are useable for non-gaming access in between gaming traffic or while game data is being loaded or rendered.

9. The method of claim 1, wherein a network non-slicing is not associated with the prioritized service.

10. The method of claim 1, wherein the network scheduling prioritizes the gaming traffic during a transmission window for a video frame.

11. A network element, comprising:
one or more processors configured to:
receive an indication of a traffic pattern associated with gaming traffic, wherein the gaming traffic is associated with a user equipment (UE);
determine that the UE is associated with a prioritized service, wherein the prioritized service is associated with network slicing; and
perform network scheduling for the UE that prioritizes the gaming traffic associated with the UE over non-gaming traffic associated with another UE, wherein the network scheduling is based on the traffic pattern and the UE being associated with the prioritized service.

12. The network element of claim 11, wherein the one or more processors, to receive the indication of the traffic pattern, are configured to:
receive, from the UE or a gaming server, the indication of the traffic pattern.

13. The network element of claim 11, wherein the one or more processors are further configured to:
identify the gaming traffic based on one or more of: a real-time transport protocol (RTP) packet header, a slice identifier mapping to a quality of service (QoS) flow, or a service profile.

14. The network element of claim 11, wherein the traffic pattern is based on one or more of a duty cycle, a transmission window, or a periodicity associated with a video frame.

15. The network element of claim 11, wherein the one or more processors are further configured to:
determine a periodicity and a duration of a scheduling prioritization based on the traffic pattern, wherein the scheduling prioritization starts when a first packet of a video frame is in a buffer and stops when a last packet of the video frame is transmitted to the UE, and the scheduling prioritization is resumed when a first packet is in the buffer for a next video frame.

16. A non-transitory computer-readable medium storing a set of instructions, the set of instructions comprising:
one or more instructions that, when executed by one or more processors of a network element, cause the network element to:
identify gaming traffic associated with a user equipment (UE);
detect a traffic pattern associated with the gaming traffic;
determine that the UE is associated with a prioritized service; and
perform, based on the traffic pattern and the UE being associated with the prioritized service, network scheduling for the UE, wherein the network scheduling assigns radio resources that prioritize the gaming traffic associated with the UE over non-gaming traffic associated with another UE.

17. The non-transitory computer-readable medium of claim 16, wherein the one or more instructions, that cause the network element to identify the gaming traffic, cause the network element to:
identify the gaming traffic based on a real-time transport protocol (RTP) packet header; or
identify the gaming traffic based on a slice identifier mapping to a quality of service (QoS) flow.

18. The non-transitory computer-readable medium of claim 16, wherein the one or more instructions, that cause the network element to detect the traffic pattern, cause the network element to:
detect the traffic pattern using a network artificial intelligence or machine learning (AI/ML) function; or
detect the traffic pattern based on one or more of a duty cycle, a transmission window, or a periodicity associated with a video frame.

19. The non-transitory computer-readable medium of claim 16, wherein the one or more instructions, when executed by the one or more processors, further cause the network element to:
determine a periodicity and a duration of a scheduling prioritization based on the traffic pattern, wherein the scheduling prioritization starts when a first packet of a video frame is in a buffer and stops when a last packet of the video frame is transmitted to the UE, and the scheduling prioritization is resumed when a first packet is in the buffer for a next video frame.

20. The non-transitory computer-readable medium of claim 16, wherein the network scheduling for the gaming traffic is associated with prioritized resources, and non-prioritized resources are useable for non-gaming access in between gaming traffic or while game data is being loaded or rendered.
